(19) United States
(12) Patent Application Publication
(10) Pub. No.: US 2020/0377332 A1
(43) Pub. Date: Dec. 3, 2020

(54) ELEVATOR SYSTEM, AND METHOD OF PREVENTING COLLISIONS BETWEEN ELEVATOR CARS

(71) Applicant: Thyssenkrupp Elevator Innovation and Operations AG, Essen (DE)

(72) Inventors: Richard Thum, Kornwestheim (DE); Marius Matz, Filderstadt (DE); Eduard Steinhauer, Nürtingen (DE)

(21) Appl. No.: 16/971,641

(22) PCT Filed: Feb. 6, 2019
(86) PCT No.: PCT/EP2019/052906

§ 371 Date: Aug. 20, 2020

(30) Foreign Application Priority Data
Feb. 20, 2018 (DE) 10 2018 202 557.6

(51) Int. Cl. B66B 1/28; B66B 9/00; B66B 5/00

(52) U.S. Cl. CPC B66B 1/28; B66B 2201/30; B66B 5/0031; B66B 9/003

(57) ABSTRACT

A method for operating an elevator system, include determining an expected stop extent with respect to the shaft axis of one of the two elevator cars, comparing the determined stop extent and the intersection extent of the shaft intersection with respect to the shaft axis of this elevator car, starting from a current position and in accordance with an expected braking distance of this car, and triggering a signal for one of the elevator cars.

The invention relates to a safety device for an elevator system with at least two elevator shafts which intersect one another at a shaft intersection and with at least two elevator cars. In addition, the invention relates to an elevator system with a first elevator shaft and a second elevator shaft, which intersects the first at a shaft intersection, and a method for operating an elevator system.

The invention can be used, for example, in elevator systems with at least two elevator cars, in particular with more than two elevator cars, which can be moved in a shaft via a guide device and which, at least theoretically, can use the same shaft intersection at the same time. At least one fixed first guide device is arranged fixedly in a first elevator shaft and is aligned in a first, in particular vertical, longitudinal direction of the shaft; at least one fixed second guide device is arranged fixedly in a second elevator shaft and aligned in a second, in particular horizontal, longitudinal direction of the shaft. The two elevator shafts intersect at a shaft intersection, at which, in order to guide the elevator cars, at least one third guide device, which is rotatable relative to the first shaft and the second shaft, is fastened to a rotating platform that is fixed to the shaft intersection, wherein the third guide device and the rotating platform can be rotated together as a shaft changing unit between an alignment in the first shaft direction and an alignment in the second shaft direction. Examples of such systems are basically described in WO 2015/144781 A1 and in the German patent applications 10 2016 211 997.4 and 10 2015 218 025.5.

However, the invention can also be used, for example, in elevator systems such as those described above, but which, for example, do not have a shaft changing unit at some of a plurality of shaft intersections, but rather only have intersecting first and second guide devices. At such shaft intersections, the elevator cars can pass through the shaft intersections at intersecting shaft axes, but cannot change shafts.

When operating elevator systems, it is fundamentally necessary to prevent, undesired collisions between moving components of the elevator system, such as, for example, the elevator car, with permanently installed components, for example components which are fixed to a shaft. Elevator systems with a plurality of elevator cars in one shaft must also be able to reliably rule out collisions between the elevator cars. Proposed solutions to this are known, for example, from patent documents EP 1 698 580 A1 or EP 2 607 282 A1.

However, in the type of elevator systems described above, with intersecting elevator shafts, it is necessary not only to avoid potential collisions between successive elevator cars or cars moving in opposite directions in a shaft longitudinal direction along a shaft axis. Rather, it must also be possible to avoid collisions between elevator cars which are traveling along different, intersecting elevator shafts.

Against this background, it is an object of the invention to provide a safety device and an improved elevator system which reduce a risk of collision between different cars, in particular those which are traveling in different shafts and whose travel paths can intersect at a shaft intersection. Likewise, a suitable method for operating an elevator system is to be provided.

This object is achieved by a safety device having the features of claim 1, an elevator system having the features of claim 6 and a method for operating an elevator system having the features of claim 12. Advantageous embodiments of the invention are the subject matter of the dependent claims. Further advantageous refinements of the invention result from the description and the exemplary embodiments illustrated in the figures.

According to one aspect of the invention, a safety device for an elevator system is provided, the elevator system comprising: at least two elevator shafts with different shaft axes that intersect at an area of a shaft intersection, and at least two elevator cars, in particular a first and a second elevator car, for moving in a shaft direction along one of the shaft axes. The safety device is configured to detect use of the shaft intersection by a first elevator car of the elevator system, referred to below as a first use, and to prevent use of the shaft intersection by a second elevator car, referred to below as a second use, for the duration of the first use. This means that the safety device serves in particular to ensure that no other elevator car of the elevator system is allowed to use this shaft intersection for the duration of the use of the shaft intersection by a first elevator car of the elevator system. A use of the shaft intersection by an elevator car of the elevator system then occurs in particular when an elevator car is at least partially inside the shaft intersection and/or when an elevator car is outside the shaft intersection but cannot be brought to a stop in front of the shaft intersection owing to the current movement of said elevator car, but when braking occurs the elevator car would come to a stop at least partially within the shaft intersection or would still pass through the shaft section before stopping, and the stopping point would therefore be after the shaft intersection.

The first use must be completely completed before a second use is allowed to take place. To further increase the safety of the elevator system, provision is advantageously made for a second use to be prevented further during a predetermined time interval after the first use has taken place and for the second use to be permitted only after the time interval has elapsed. The length of this time interval advantageously depends on the speed at which the elevator cars of the elevator system are moved in the elevator shafts. In particular, the time interval can be between 0.5 seconds and 5 seconds. However, the provision of such a time interval is optional.

If the elevator cars of the elevator system are moved along correspondingly energized guides by means of a linear motor drive, provision can be made for preventing a second use, the corresponding guide rails for the elevator cars can be disconnected from the power supply to prevent second use.

According to a further aspect of the invention, a safety device for an elevator system is provided, the elevator system comprising: at least two elevator shafts with different shaft axes which intersect at an area of a shaft intersection, and at least two elevator cars, in particular a first and a second elevator car, for moving in a shaft direction along one of the shaft axes. The safety device is configured to determine an expected stop extent of this elevator car with respect to the shaft axis of this elevator car, on the basis of a current position of one of the two elevator cars and in accordance with an expected braking distance, and to compare the determined stop extent and an intersection extent of the shaft intersection with respect to the shaft axis of this elevator car. Advantageously, the safety control device is further configured to trigger a stop signal for the other of the two elevator cars in a further step if the comparison reveals an expected overlap between the stop extent and the intersection extent.

In particular, it is provided that the safety device is configured to determine an expected stop extent of one of the two elevator cars with respect to the shaft axis of the elevator car, starting from a current position of one of the two elevator cars and depending on an expected braking distance of the car, and to compare the determined stop extent to an intersection extent of the shaft intersection with respect to the shaft axis of this elevator car, and then to detect a first use of the shaft intersection if the comparison shows an expected overlap between the stop extent and the intersection extent. Furthermore, the safety device is advantageously configured to trigger a stop signal for the second elevator car to prevent the second use by the other of the two elevator cars.

According to a further aspect of the invention, an elevator system, in particular an elevator system comprising a linear motor drive, is provided, the elevator system having:

a) a first elevator shaft with a first guide device which is fixed to the shaft and parallel to a first, in particular vertical, shaft axis. The first guide device is in particular fixedly arranged in the first elevator shaft and aligned along the first shaft axis. The first guide device has in particular at least one first guide rail, on which one or more elevator cars can be guided along the first shaft axis in both first longitudinal directions through the first elevator shaft.

b) a second elevator shaft with a second guide device which is fixed to the shaft and parallel to a second, in particular horizontal, shaft axis. The second guide device is in particular fixedly arranged in the second elevator shaft and is aligned along the second shaft axis, the second elevator shaft intersecting the first elevator shaft at a shaft intersection. The shaft intersection is designed in particular in such a way that at said intersection elevator cars can pass (of course not simultaneously) along the first shaft axis or along the second shaft axis, possibly with an operational stop in the area of the shaft intersection.

c) at least two elevator cars that can be moved along the guide devices, each with a first elevator car extent along the first shaft axis and a second elevator car extent along the second shaft axis. The elevator car can in particular be movable along at least two different shaft axes. In the elevator system, in particular, several elevator cars are provided, which normally all have at least essentially the same elevator car extents. An elevator car extent is to be understood in particular as a maximum extent, or length, of the elevator car along one of the shaft axes.

d) a control unit for controlling a travel movement of the elevator cars. The control unit can in particular be configured separately for one or more cars and/or as a logical and/or physical part of a control device of the elevator system. In particular, the control unit is an appropriately programmed, customary industrial controller and/or at least one component thereof. The control unit is in particular configured to monitor movement specifics of the elevator cars and/or of the third guide device, for example by evaluating sensor values and/or operating models.

The control unit and/or the elevator system also has a safety device according to an embodiment of the invention. If in the following a property or a characteristic of the control unit is mentioned, this property or this characteristic can also be attributed to the safety device, insofar as this makes sense.

According to a further aspect of the invention, a method for operating an elevator system is provided, wherein the elevator system can be designed according to an embodiment of the invention. In particular, the elevator system has at least two elevator shafts with different shaft axes that intersect at a shaft intersection and at least two elevator cars for moving in a shaft direction along one of the shaft axes. In the method, a use of the shaft intersection by a first elevator car detected as a first use, and use of the shaft intersection by a second elevator car as a second use is prevented, at least for the duration of the first use.

The method advantageously also has the following method steps: determining an expected stop extent with respect to the shaft axis of one of the two elevator cars, starting from a current position and as a function of an expected braking distance of this elevator car, and comparing the determined stop extent and the intersection extent of the shaft intersection with respect to the shaft axis of this elevator car. Advantageously, according to the method, a first use is then detected in particular when the comparison shows an expected overlap between the stop extent and the intersection extent. The second use is also advantageously prevented by triggering a stop signal for the second elevator car.

The invention is based, inter alia, on the knowledge that in elevator systems with intersecting elevator shafts a large number of potential collision risks occur which do not exist in classic elevator systems with a single elevator shaft or plurality of parallel shafts.

If, for example, a shaft intersection has only guide devices that intersect one another, there is a certain intersection extent at which elevator cars which are being moved in the intersecting shafts can collide. If, for example, the shaft intersection also has a shaft changing unit, there is also a risk of collision for elevator cars that are traveling in a shaft direction with which the shaft changing unit is not currently aligned.

In addition, the invention is based, inter alia, on the knowledge that entry of another elevator car from a different shaft direction into the intersection extent must be avoided if another elevator car is already arranged in the intersection extent or if owing to the specific movement of the other elevator car it is unavoidable that the other elevator car will reach the intersection extent. This is the case, for example, if, despite maximum braking, it is no longer possible to avoid the other elevator car entering the intersection extent.

The invention is now based, inter alia, on the idea of assigning a stop signal to elevator cars which are moving toward the shaft intersection when another elevator car is already in the intersection extent and/or it is inevitable that the other elevator car enter the intersection extent—for example also in the event of an emergency stop that is triggered immediately, in particular an emergency stop triggered by the triggering of safety gear. According to one embodiment, a stop signal can also be arbitrarily issued for one or more elevator cars, which can still stop in good time in order to prioritize another elevator car for the passage through the shaft intersection.

In the present case, a stop signal is to be understood in particular to mean a signal from the control unit, in particular from the safety device, which ensures that an elevator car affected by the stop signal does not enter the intersection extent while the stop signal is occurring. For this purpose, in particular a braking process with a maximum and/or predetermined intensity and/or duration can be initiated. The stop signal for the elevator car concerned can be canceled, for example, if the elevator car triggering the stop signal has passed the shaft intersection and/or if there is no longer a risk of a collision owing to the relative movement specifics (positions, speeds, accelerations) of the two elevator cars.

In particular, the stop signal is designed such that at least one of the following actions mentioned is triggered for the elevator car for which a second use is to be prevented, hereinafter called the second elevator car: the second elevator car is stopped; the direction of travel is reversed for the second elevator car; the second elevator car will be moved on normally, outside of a defined environment of the shaft intersection, for example a distance from the shaft intersection that in each direction corresponds to a multiple of the braking distance of an elevator car, in particular to 1.0 to 3.0 times the braking distance of an elevator car that approaches the shaft intersection; the second elevator car is prevented from continuing; the second elevator car is stopped at a stop, preferably with the elevator car doors open; and emergency braking is triggered for the second elevator car, in particular by activating a safety gear of the elevator car.

When an elevator car is referred to here, it is primarily an elevator cab for transporting people and/or loads; however, the term elevator car also includes maintenance vehicles, breakdown vehicles, etc. in the elevator shaft, in particular those that can also be moved on the guide devices.

In order to facilitate a real-time control concept and/or integration of the control of the third guide device into a superordinate control system of the elevator system, according to one embodiment the control unit, in particular the safety device, has access to an operating model, in particular to a control model and/or a state model, of the elevator system, from which it is possible to determine: 1) the elevator car dimensions of the elevator car which are to be used for calculating the elevator car extent, and/or 2) the intersection extents of the shaft changing unit which is to be used, and/or 3) the braking distances of the elevator car which are to be used, as a function of a velocity, and/or 4) the elevator car dimensions which are to be used for the intersection extent.

In the present case, a braking distance of the elevator car can also presently for example be understood in the sense of a stopping distance to mean the entire distance along an elevator shaft, which is required when braking becomes necessary in order to first determine the necessity (for example by means of the control unit) and then initiate braking and to bring it to a conclusion (for example by means of the control unit in cooperation with at least one brake element and/or gravity).

In particular, the control unit, in particular the safety device, can have recourse to at least one operating model of the elevator system and/or of an elevator car and/or of a shaft changing unit. This recourse can take place in particular through a wired or wireless connection to a database, the database being stored, for example, in a memory of the control unit itself and/or on a company server and/or in a cloud-based memory.

Such an operating model can be understood to mean, for example, a control model with a table in which different occurrences of at least one influencing variable (for example with an influence on the travel movement of the elevator car and/or the alignment movement of the shaft changing unit) are each related to in each case at least one value of at least one control variable which is to be influenced by means of the control unit.

In the present case, for example, combinations of a position of the elevator car along a shaft axis and elevator car dimensions along this shaft axis can be linked on the one hand with a statement as to whether part of the intersection extent also lies along this elevator car extent. If this is the case, the stop signal can be triggered, for example, for another elevator car.

By means of such a control model, the control unit, in particular the safety device, can determine whether a stop signal is required depending on the determined combination of the elevator car extent and intersection extent. The tables required for this can be derived, for example, from relationships between an influencing variable and a control variable determined experimentally and/or by means of computer models and stored in the database, and can be part, for example, of a so-called ‘digital twin’ of the device.

Additionally or alternatively, an operating model of the elevator system and/or the third guide device can be understood to mean, for example, a state model with a table in which various occurrences of at least one auxiliary variable, on the occurrence of which at least indirectly an occurrence of an influencing variable (with influence on the elevator system and/or the elevator cars) depends, are respectively related to at least one occurrence of this influencing variable in each case.

In the present case, for example, expressions of auxiliary variables such as a motor current, a motor torque and/or an increment of a rotation angle of a drive motor of the elevator car can be linked to a statement about the position of the shaft axis at which the elevator car is currently being moved and the velocity at which it is being moved. Such a state model can be used to determine a presently existing occurrence of the influencing variable, in particular even without resorting to sensor detection of occurrences of the influencing variable. The determined occurrence can then be fed, for example, into a control model of the operating model, in order to suitably control the elevator system and/or the elevator cars. The tables required for this can be derived, for example, from relationships between an influencing variable and a control variable determined experimentally in the development phase and/or by means of computer models and stored in the database, and can be part, for example, of a so-called ‘digital twin’ of the device.

In order to further improve the collision safety, according to one embodiment the stop signal is designed such that the elevator car for which the stop signal is triggered is placed in a safe state, in particular with the drive switched off and the brakes activated to a maximum degree.

In order to be able to prioritize entering of the elevator cars into intersections, according to one embodiment there is provision for all the elevator cars to be continuously monitored while the elevator system is operating. According to one embodiment, this monitoring means in particular that it is continuously determined for each elevator car whether entry into an intersection can still be avoided. Then, according to one embodiment, the control unit, in particular the safety device, can trigger the stop signal for one of the two elevator cars if the comparison shows that the stop extent and the intersection extent are not expected to overlap, in particular if there is additionally a collision risk operating state at the shaft intersection. If one or more elevator cars are in this way prevented from entering the intersection, this results in the possibility of preferably enabling a particular elevator car to enter the intersection.

In order to be able to reliably prevent collisions even in operating cases in which an elevator car has already entered the intersection extent, according to one embodiment the safety device is configured to iv) determine a current elevator car extent of the one of the two elevator cars of the elevator system with respect to the shaft axis of this elevator car, v) to compare the determined current elevator car extent and the intersection extent, and vi) to trigger the stop signal for the other of the two elevator cars if the comparison shows an overlap between the stop extent and the intersection extent, in particular if there is also a collision risk operating state at the shaft intersection.

In order to enable a simple and/or flexible design of the elevator system, according to one embodiment it has at least one shaft intersection, at which it is only possible to pass through (or of course to stop with subsequent onward travel or reversing), but changing the shaft direction is not possible. For this purpose, according to one embodiment, the first guide device runs along the first shaft axis through the shaft intersection and the second guide device runs along the second shaft axis through the shaft intersection. In such an elevator system, according to one embodiment, the intersection extent with respect to the first shaft axis corresponds to the elevator car extent with respect to the first shaft axis of an elevator car arranged along the second shaft axis. In this embodiment, the intersection extent with respect to the second shaft axis corresponds to the elevator car extent of an elevator car arranged along the first shaft axis with respect to the second shaft axis.

In order to be able to provide an elevator system with the possibility of changing the shaft direction, according to one embodiment, at least one shaft changing unit is arranged at the shaft intersection in a rotationally fixed manner with a third guide device for elevator cars of the elevator system, the shaft changing unit being aligned along an alignment path between an orientation along the shaft axis of the one elevator shaft and one alignment along the shaft axis of the other elevator shaft can be transferred. In such an elevator system, according to one embodiment, the intersection extent with respect to the first shaft axis corresponds to a maximum extent of the, in particular alignable, components of the shaft changing unit with respect to the first shaft axis. In this embodiment, the intersection extent with respect to the second shaft axis corresponds to a maximum extent of the, in particular alignable, components of the shaft changing unit with respect to the second shaft axis.

For ongoing use of the safety device during operation of the elevator system, according to one embodiment, the safety device is configured to simultaneously carry out a method for each of the elevator cars, according to one of the following claims, in particular in each case many times per second.

For simpler control of the stop signal, the braking distance is determined according to one embodiment as a function of a speed of the elevator car, and in particular also in accordance with an operating model designed as a braking distance state model, and/or the stop extent is determined as a function of an extent of the elevator car.

In order to limit the collision protection to a necessary area around the shaft intersection and thus not to interfere unnecessarily in the operation of the elevator system, according to one embodiment, a second use is only then actively prevented or the stop signal is triggered only if there is a collision risk operating state. A collision risk operating state, in particular with respect to (or at) a shaft intersection, is present in particular when the other of the two elevator cars is within an intersection environment and/or when the other of the two elevator cars is moving towards the shaft intersection, and/or when it is clear from the planted operating sequence of the elevator system that a movement of the other of the two elevator cars towards the shaft intersection is imminent. For example, the stop signal can be triggered when the elevator car affected by the stop signal is within the intersection area and is also moving toward the shaft intersection.

In the present case, an intersection environment of a shaft intersection is to be understood to mean in particular an extent area along the elevator shafts which form the shaft intersection, which extent area is not sufficient, in the case of maximum braking from a maximum provided elevator car speed, to restrain the elevator car before it reaches the intersection extent. For example, the intersection environment along each of the four shaft directions is then defined starting from the respective boundary of the intersection extent through this extent area.

According to one embodiment, in the method, the stop extent of an elevator car along whose direction of travel the third guide device of the shaft changing unit of the shaft intersection is aligned is first determined.

According to one embodiment of the method, the stop signal for one of the two elevator cars is triggered if the comparison shows that the stop extent and the intersection extent are not expected to overlap.

According to one embodiment, the method additionally has the steps: iv) determining a current elevator car extent of one of the two elevator cars of the elevator system with respect to the shaft axis of this elevator car, v) comparing the determined current elevator car extent and the intersection extent, and vi) triggering the stop signal for the other of the two elevator cars, if the comparison shows an overlap between the elevator car extent and the intersection extent.

In order for the invention to work in particular with a common type of guide arrangement such as a backpack guide, according to one embodiment the guide devices have at least one guide rail (and preferably consist of at least one guide rail), so that the third guide device of the shaft changing unit has a third guide rail which for the purpose of alignment can rotate along an alignment section which is embodied as a rotational section and which is fixedly arranged on a rotating platform of the shaft changing unit, which rotating platform is in particular at least indirectly attached to a shaft wall of the shaft intersection.

The term elevator shaft is then used here only if the elevator shaft has its own boundary walls. For example, there are two elevator shafts in the present case if they are arranged parallel to one another without an intermediate wall and/or if they intersect one another without the shaft intersection being delimited by shaft walls. The term shaft can also relate here to the movement trajectory of the elevator car and is not purely limited to the presence of shaft walls.

Further features, advantages and possible uses of the invention result from the following description in conjunction with the figures. The figures show:

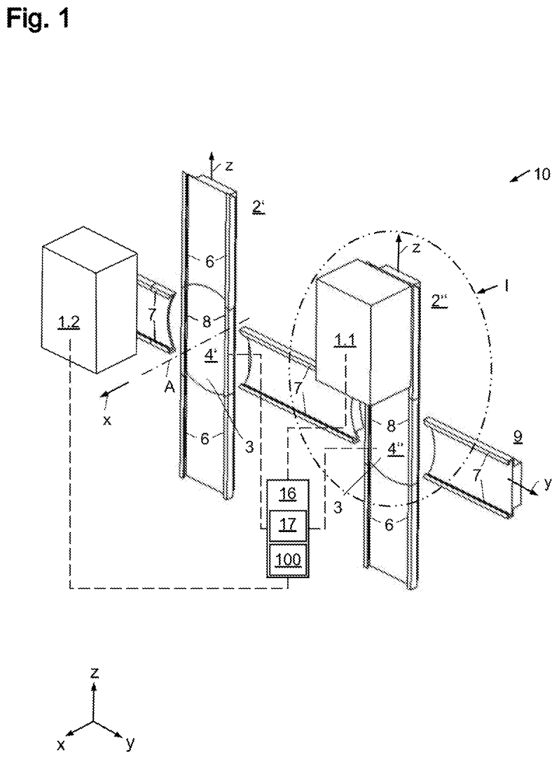

FIG. 1 shows, in a schematic oblique view, the basic structure of an elevator system with a safety device according to an exemplary embodiment of the invention;

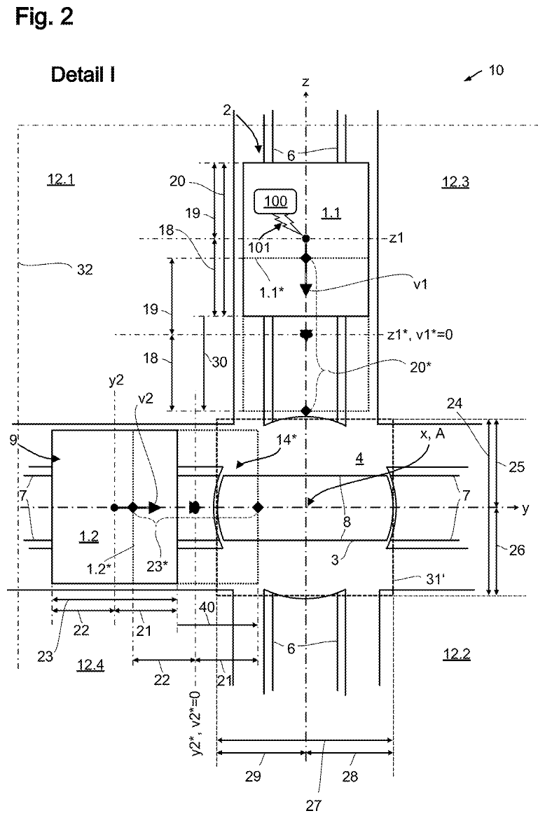

FIG. 2 shows, in a schematic side view, the area I of the elevator system marked in FIG. 1 with a shaft intersection in a first operating case of the safety device, in which a stop signal for a vertical moved elevator car is triggered in accordance with a first exemplary method;

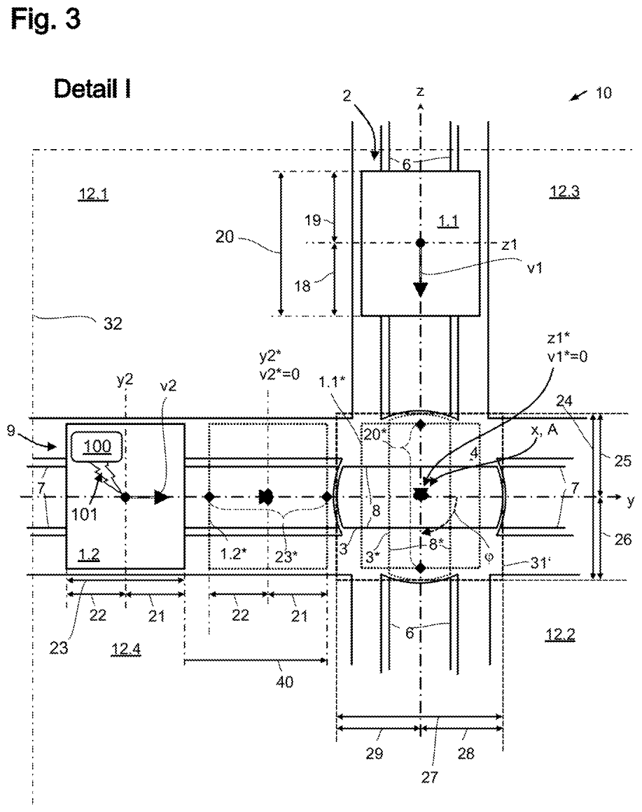

FIG. 3 shows the schematic side view from FIG. 2 in a second operating case of the safety device, in which a stop signal for a horizontally moved car is triggered in accordance with a second exemplary method; and

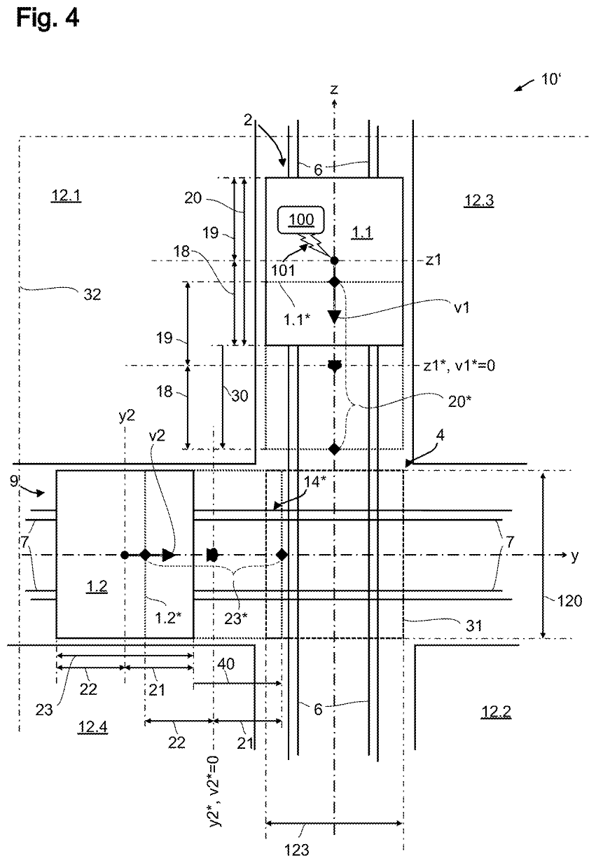

FIG. 4 shows, in a schematic side view analogous to FIG. 2, an elevator system according to another exemplary embodiment of the invention with a simpler designed shaft intersection, in a third operating case of the safety device, in which a stop signal for a vertically moved elevator car is triggered according to a third exemplary method.

FIG. 1 shows parts of an elevator system 10 according to the invention. The elevator system 10 comprises fixed first guide devices 6 embodied as guide rails, along which each of at least two, in particular at least essentially identical, elevator cars 1.1, 1.2 can be guided using backpack mounting. The first guide devices 6 are aligned vertically in a first shaft direction z and enable, for example, the elevator car 1.1 (illustrated as a representative of all the vertically moving elevator cars) to be moved between different floors. Arranged parallel to one another in two parallel first vehicle shafts 2′, 2″ are arrangements of such first guide devices 6, along which the elevator cars 1 can be guided using backpack mounting. Elevator cars in which one shaft 2′ can move on the respective first guide devices 6, largely independently and unhindered by elevator cars 1 in the other shaft 2″.

The elevator system 10 further comprises fixed second guide devices 7 which are embodied as guide rails, along which each of the elevator cars 1 (here, the elevator car 1.2 illustrated as representative of all the elevator cars) can be guided using backpack mounting. The second guide devices 7 are aligned horizontally in a second shaft direction y and enable the elevator cars 1 to be moved within one floor. The second guide devices 7 also connect the first guide devices 6 of the two shafts 2′, 2″ to one another. Thus, the second guide devices 7 also serve to transfer and relocate the elevator car 1 between the two shafts 2′ and 2″, in order, for example, to implement a modern paternoster operation.

In the exemplary embodiment, the second guide devices 7 run along a second elevator shaft 9 which intersects the two first elevator shafts 2′ and 2″ at a respective shaft intersection 4′ and 4″. In other exemplary embodiments in the sense of the invention, the shaft intersection can also be embodied in the form of a T junction.

At these shaft intersections 4′ and 4″, the elevator car 1 can be respectively transferred from the first guide devices 6 onto the second guide devices 7 and vice versa, in each case via third guide devices 8 embodied as guide rails. The third guide devices 8 are rotatable with respect to an axis of rotation A which is perpendicular to a y-z plane (and thus parallel to an x axis of the elevator system) which is spanned by the first and the second guide devices 6, 7.

All the guide rails 6, 7, 8 are at least indirectly attached to at least one shaft wall of a shaft 2 and/or a shaft 9. The shaft wall defines in particular a stationary reference system for the shaft. The term shaft wall also in particular alternatively includes a stationary frame structure of the shaft which carries the guide rails. The rotatable third guide rails 8 are fastened on a rotating platform which, together with at least the third guide devices, forms a shaft changing unit 3.

Such systems are basically described in WO 2015/144781 A1 and in the German patent applications 10 2016 211 997.4 and 10 2015 218 025.5. In this context, 10 2016 205 794.4 describes in detail an arrangement with an integrated platform pivot bearing and a drive unit for rotating the rotating platform 3, which arrangement can also be used, for example, as part of the present invention for mounting and as a rotary drive for the shaft changing unit 3.

In FIGS. 2 and 3, the section I of the elevator system 10 marked with a double-dotted chain line in FIG. 1 is in each case enlarged and shown with more details. While the elevator car 1.2 is shown in FIG. 1 on the left of the shaft intersection 4′ due to better illustration, it is shown in FIGS. 2 and 3 on the left of the shaft intersection 4″ in order to better describe the exemplary embodiments of the invention. The shaft intersection 4″ from FIG. 1 is designated by the reference number 4 in FIGS. 2 and 3, because in any case it stands for each shaft intersection 4 of the elevator system.

FIG. 2 shows detail I of the elevator system 10 in a first operating case, in which an elevator car 1.1 moves vertically downward and an elevator car 1.2 moves horizontally to the right toward the shaft intersection 4. The movement of these and possibly of other elevator cars 1 is monitored continuously—that is, many times per second—by means of an exemplary safety device 100. At the time shown, the elevator car 1.1 is located at the position z1 in the elevator shaft 2 and moves toward the shaft intersection 4 at the speed v1. The elevator car 1.2 is located at the position y2 and is also moving toward the shaft intersection 4 at the speed v2.

In the exemplary embodiment, the safety device 100 monitors whether the shaft intersection 4 has to be blocked for certain elevator cars to prevent, in particular to avoid, collisions of elevator cars 1, for example because it is no longer possible to prevent another elevator car from entering the shaft intersection 4 at the recorded time. The exemplary method is shown below in respect of the monitoring of the elevator car 1.2.

Step i): The safety device 100 first determines the current position y2 and the current speed v2 of the elevator car 1.2 using suitable sensors (not illustrated) and/or by using an operating model 17. Using a braking distance status model in operating model 17, the safety device determines an expected stop position y2* of the elevator car 1.2 (see reference number 1.2*) by extracting information from an expected braking distance 40 at the determined speed v2 from the operating model 17. The stop extent 23* which is to be expected along the second shaft axis y is determined from the stop position y2*. The stop extent 23* of the elevator car 1.2 after it passes through the braking distance 40 and brakes completely to v2*=0 is presented in the illustration by the two black lozenges at both ends of the stop extent 23*.

Step ii): The determined stop extent 23* is compared by means of the safety device 100 with an intersection extent 27 with respect to the second shaft axis y. The intersection extent 27 is determined in particular from a maximum extent 28, 29 of the alignable components of the shaft changing unit 3 with respect to the second shaft axis y (in particular at most with respect to all the possible orientations along an alignment section φ).

Step iii): If the comparison from step ii shows an expected overlap 14* between the stop extent 23* and the intersection extent 27, a first use is advantageously recognized in this way. For the duration of the first use, the safety device prevents a second use, that is to say in particular the entry of a further car 1.1 into the shaft intersection 4. In this exemplary embodiment, in order to prevent a second use the safety device 100 triggers a stop signal 101 for other elevator cars 1 that are currently moving towards the shaft intersection 4 within an intersection environment 32. In the operating case shown, there is such an overlap 14* between the stop extent 23* and the intersection extent 27. The consequently triggered stop signal 101 of the safety device 100 relates to the elevator car 1.1, because in the operating case shown it is currently the only other elevator car 1 arranged within the intersection environment 32 and is approaching the shaft intersection 4.

As can be seen from the illustration in FIG. 2, the stop signal 101 for the elevator car 1.1 was triggered in good time. After receiving the stop signal 101, the elevator car 1.1 can be braked sufficiently to come to a stop (v1=0)after passing through a braking distance 30 at a stop position z1*. At this stop position z1*, the stop extent 20* does not yet extend along the first shaft axis z to such an extent that it would overlap with the intersection extent 24 along the first shaft axis z. In this way, a risk of a collision between the two elevator cars 1.2 and 1.1 is excluded.

3 shows an operating case in which, analogously to the operating case in FIG. 2, it is first determined whether there is an overlap 14* between the intersection extent 27 and the stop extent 23* of the elevator car 1.2 under desired and/or maximum braking conditions (corresponds to predetermined or minimal braking distance 40) can still be avoided at all. In contrast to the operating case in FIG. 2, it is determined in the present operating case that timely braking of the elevator car 1.2 is still possible. As can be seen (see reference numbers 1.2* and 23*) there is no overlap.

This leaves room for prioritization of entry into an intersection of the approaching elevator car 1.1 which is desired in the exemplary embodiment. In order to implement this prioritization, the procedural steps described below are carried out:

After it has been established that the elevator car 1.2 can still be braked in good time, the stop signal 101 is triggered immediately for this elevator car 1.2, so that the braking process is started without delay. In addition, the control device 16 triggers an alignment movement (cf. reference symbol φ) of the shaft changing unit 3 about its axis of rotation A in order to align the third guide devices 8 in the direction of the first guide devices 6 (cf. reference symbols 3* and 8*).

This can be done relatively quickly, so that the elevator car 1.1 can enter the intersection 4 as desired and, for example (in particular for people to get in and out), can come to a stop at the intersection point of the two shaft axes z, y, as shown in FIG. 3 is (cf. reference numerals 1.1* and 20*).

The elevator car 1.1 can then also either continue to move up or down along the first shaft axis y in the first elevator shaft, or the shaft changing unit 3 is moved back in the opposite direction to the previous alignment, and the elevator car 1.1 continues its journey to the right along the second elevator shaft 9. In both cases, the intersection 4 can be released again for the other elevator car 1.2 by stopping the stop signal 101 as soon as the elevator car 1.1 has left the extent of the intersection (or by means of the safety device 100 it is ensured that a collision is not longer possible owing to the movement specifics of the two elevator cars).

FIG. 4 shows another, simpler elevator system 10′, which differs from the elevator system 10 in FIGS. 1 to 3 in particular by having a simpler design at the shaft intersection 4. No shaft changing unit is installed there, so that no shaft change of an elevator car 1 can take place at this shaft intersection. Instead, the first guide devices 6 run in the vertical direction z and the second guide devices 7 in the horizontal direction y through the shaft intersection 4, so that both an uninterrupted passage and a stop of the elevator car with subsequent continuation of travel or return is possible.

At such a shaft intersection 4, the intersection extent 120 with respect to the first shaft axis z corresponds to the elevator car extent 20 of an elevator car 1 arranged along the second shaft axis y with respect to the first shaft axis z. The intersection extent 123 with respect to the second shaft axis y corresponds to the elevator car extent 23 of an elevator car 1 arranged along the first shaft axis z with respect to the second shaft axis y.

In the exemplary embodiment in FIG. 4, apart from the different design of the shaft intersection 4, the operating case from FIG. 2 is shown analogously, the intersection extent 120, 123 being made smaller in the embodiment in FIG. 4 owing to the absence of the shaft changing unit. A collision is possible only in an intersection area 31 which corresponds to a contour of the elevator cars 1 used in the elevator system 10′.

Despite the smaller intersection extent 123, when a method analogous to that described in FIG. 2 is used, there is an overlap 14* with respect to the second shaft axis y with the stop extent 23* of the elevator car 1.2. Consequently, a stop signal 101 must be triggered for the elevator car 1.1.

The explanations for the figures are limited to methods based on the elevator car 1.2. However, the method according to one of the embodiments described above is also carried out analogously by means of the safety device 100 starting from other elevator cars, such as for example the elevator car 1.1, preferably in parallel and simultaneously for all the elevator cars 1 present in the elevator system 10.

### LIST OF REFERENCE DESIGNATIONS

1 Elevator car

2 First elevator shaft (for example vertical)

3 Shaft changing unit

4 Shaft intersection

6 First guide device (for example guide rail)

7 Second guide device (for example guide rail)

8 Third guide device (for example guide rail)

9 Second elevator shaft (for example horizontally)

10 Elevator system

12 Shaft wall

14 Overlap between elevator car extent and intersection extent

16 unit

17 Operating model

18, 19 First elevator car dimensions

20 Elevator car extent along the vertical shaft axis

21, 22 Second elevator car dimensions

23 Elevator car extent along the horizontal shaft axis

24 First intersection extent

27 Second intersection extent

25, 26, 28, 29 Portions of the second intersection extent

30 Braking distance of the elevator car

31 Intersection area

32 Intersection environment

100 Safety device

120, 123 First intersection extent, second intersection extent

φ Alignment distance

v Speed of an elevator car

x;A Depth axis of the elevator car; Axis of rotation of the third guide device

y Extent axis of a second elevator shaft

z Extent axis of a first elevator shaft

z1, y2 Position of an elevator car

1.-16. (canceled)

17. A programmable control unit for controlling and monitoring an elevator system, the elevator system including at least two elevator shafts with different shaft axes that intersect at an area of a shaft intersection, and at least two elevator cars for moving in a shaft direction along one of the shaft axes, the control unit comprising:
a safety device containing program instructions that when executed in the control unit are configured to:
detect use of the shaft intersection by a first elevator car of the elevator system as a first use, and
prevent the shaft intersection from being used by a second elevator car as a second use, at least for the duration of the first use.

18. The programmable control unit of claim 17, wherein the safety device is further configured to:
determine an expected stop extent of the first elevator car with respect to the shaft axis of the first elevator car starting from a current position of the first elevator car and in accordance with an expected braking distance,
compare the determined stop extent to an intersection extent of the shaft intersection with respect to the shaft axis of the first elevator car, and
detect a first use of the shaft intersection if the comparison shows an expected overlap between the stop extent and the intersection extent.

19. The programmable control unit of claim 17, wherein the safety device is further configured to prevent a second use and trigger a stop signal for the second elevator car.

20. The programmable control unit of claim 19, wherein the stop signal is configured to at least one of:
stop movement the second elevator car,
reverse the direction of travel of the second elevator car,
continue to permit the second elevator car to move further along its normal travel path and outside of a defined area of the shaft intersection,
prevent the second elevator car from continuing with its travel,
hold the second elevator car at a stop destination with its car doors open, or
trigger an emergency brake in the second elevator car.

21. The programmable control unit of claim 17, wherein the safety device is further configured to,
determine a current elevator car extent of the first elevator car with respect to the shaft axis of this first elevator car,
compare the determined current elevator car extent to the intersection extent, and
detect first use if the comparison shows an overlap between the elevator car extent and the intersection extent.

22. An elevator system, comprising:
a first elevator shaft having a first guide device affixed thereto and positioned parallel to a first shaft axis;
a second elevator shaft having a second guide device affixed thereto and positioned parallel to a second shaft axis, wherein the second elevator shaft intersects the first elevator shaft to define an area of a shaft intersection;
at least two elevator cars which can be moved along the guide devices with a first elevator car extent along the first shaft axis and a second elevator car extent along the second shaft axis; and
a control unit for controlling a travel movement of the elevator cars, wherein the control unit includes a safety device configured to, detect use of the shaft intersection by a first elevator car of the elevator system as
a first use, and
prevent the shaft intersection from being used by a second elevator car as a second use, at least for the duration of the first use.

23. The elevator system of claim 22, wherein the first guide device runs along the first shaft axis through the shaft intersection and the second guide device runs along the second shaft axis through the shaft intersection.

24. The elevator system of claim 23, wherein the intersection extent with respect to the first shaft axis corresponds to the elevator car extent of an elevator car which is arranged along the second shaft axis with respect to the first shaft axis, and the intersection extent with respect to the second shaft axis corresponds to the elevator car extent of an elevator car arranged along the first shaft axis with respect to the second shaft axis.

25. The elevator system of claim 22, further comprising:
at least one shaft changing unit rotatably coupled to a shaft wall in the area of the shaft intersection;
a third guide device coupled to the shaft changing unit in a rotationally fixed manner and along which elevator cars of the elevator system travel, wherein the shaft changing unit and the attached third guide device can be rotated together along an alignment path between an alignment along the shaft axis of the one elevator shaft and an alignment along the shaft axis of the other elevator shaft.

26. The elevator system of claim 25, wherein the intersection extent with respect to the first shaft axis corresponds to a maximum extent of the shaft changing unit with respect to the first shaft axis, and the intersection extent with respect to the second shaft axis corresponds to a maximum extent of the shaft changing unit with respect to the second shaft axis.

27. A method for operating an elevator system having at least two elevator shafts with different shaft axes which at least two elevator shafts intersect at a shaft intersection, and at least two cars for moving in a shaft direction along one of the shaft axes, the method comprising:
permitting a first elevator car of the elevator system to occupy the area of the shaft intersection, as a first use; and
protecting the first elevator car while it is located in the shaft intersection by preventing a second elevator car from using the shaft intersection, as a second use, for the duration of the first use of the shaft intersection by the first elevator car.

28. The method of claim 27, further comprising:
determining an expected stop extent with respect to the shaft axis of the first elevator car, starting from a current position and in accordance with an expected braking distance of this first elevator car;
comparing the determined stop extent and the intersection extent of the shaft intersection with respect to the shaft axis of this first elevator car; and
detecting a first use if the comparison shows an expected overlap between the stop extent and the intersection extent.

29. The method of claim 27, wherein the second use is prevented by triggering a stop signal for the second elevator car.

30. The method of claim 27, further comprising:
determining a current elevator car extent of the first elevator car with respect to the shaft axis of this first elevator car;
comparing the determined current car extent and the intersection extent; and
detecting a first use if the comparison shows an overlap between the elevator car extent and the intersection extent.

31. The method of claim 27, further comprising:
actively controlling the second elevator car to prevent the second use of the shaft intersection by the second elevator car, if at least one of the following conditions are met:
the second elevator car is located within a defined shaft intersection environment;
the second elevator car is moving toward the shaft intersection;
a movement of the second elevator car toward the shaft intersection is imminent during a planned operating sequence of the elevator system;
a communication fault has been detected in relation to the second elevator car;
a stop extent for the second elevator car overlaps with a defined shaft intersection environment.
